(19) United States
(12) Patent Application Publication
(10) Pub. No.: US 2016/0081344 A1
(43) Pub. Date: Mar. 24, 2016

(54) Agricultural Pesticide Formulations

(71) Applicants: Prakash Jadhav, Mumbai (IN); Jaidev Rajnikant Shroff, Dubai (AE); Satish Ekanath Bhoge, Thane (IN)

(72) Inventors: Prakash Jadhav, Mumbai (IN); Jaidev Rajnikant Shroff, Dubai (AE); Satish Ekanath Bhoge, Thane (IN)

(73) Assignee: UPL Limited, Mumbai (IN)

(21) Appl. No.: 14/961,394

(22) Filed: Dec. 7, 2015

Related U.S. Application Data
(63) Continuation-in-part of application No. 12/775,888, filed on May 7, 2010, now Pat. No. 9,204,629.

(51) Int. Cl. A01N 53/00

(52) U.S. Cl. CPC A01N 53/00

(57) ABSTRACT

The present invention provides for a granular agricultural pesticide formulation of reduced toxicity and good heat and storage stability containing an insecticidally effective amount of bifenthrin; a carrier selected from the group consisting of precipitated silica, colloidal silica, attapulgite, china clay, talc, kaolin and combination thereof; a surfactant; and a diluent.

### CROSS-REFERENCE TO RELATED APPLICATIONS

The present application claims priority to U.S. patent application Ser. No. 12/775,888, filed May 7, 2010, the entire contents of which is incorporated herein by reference.

### BACKGROUND OF THE INVENTION

1. Field of the Invention

The present invention relates to pesticide compositions. In particular, the present invention relates to solid compositions containing Bifenthrin, further comprising carrier, surfactant and diluent, and optionally wetting agents, dispersing agents and formulation auxiliaries. This invention is particularly suitable in providing a solid pesticide composition having lower toxicity yet greater suspensibility and dispersion than previously known pesticide compositions.

2. Description of the Related Art

There are a large number of Bifenthrin formulations that are being used for combating pest attacks on plants. Available formulations include emulsion concentrates, aqueous suspensions, and powder that is contained in water-soluble bags. Such formulations are widely available in market for a good number of years; however, the users have regularly encountered various technical difficulties with these available formulations.

Quality of a pesticide formulation is greatly dependent on its physicochemical properties. These physicochemical properties are significantly altered by factors such as moisture content in the final composition inter alia on the method of its drying, temperature, purity of the active contents and the raw material etc.

Disadvantageously, unsatisfactory non-uniform dissolution (dispersion) of the composition leads to lack of homogeneity in the resulting mixture and prevents distribution of constant concentration of the desired active in the fields. The use of water soluble bags to contain Bifenthrin powder so as to reduce its toxicity often leads to such undesirable dispersion. Because the dispersion is unsatisfactory, the less than optimal concentration of the active pesticide applied to the fields lead to waste of the pesticide, and risk increasing the resistance of insect pests to the pesticide.

Also, of the formulations available in the market, some employ organic solvents, such as emulsions concentrates that contain petroleum-based solvents, causing nuisance to the environment.

Bifenthrin coated granules are also available in the market, which has a very low content of Bifenthrin, e.g., 0.2%, and are used for nursery and gardens due to the low content of the active. These granules are applied directly onto the ground. The granules then release the active over time as it rains. The low content of bifenthrin precludes the use of this granular product for general agricultural applications.

Though there are different formulation types available in the market there is a need for a Bifenthrin solid composition of low toxicity that could packed and used without the use of water soluble bags, which overcomes one or more problem, faced in the art.

### SUMMARY OF THE INVENTION

Accordingly, it is an object of the present invention to provide a pesticide compositions or formulations, which can have, in practice, a low toxicity that could be directly used upon mixing with water.

Another object of the present invention is to provide products of superior suspensibility and dispersion; and higher storage stability.

In accomplishing the forgoing objects, the present invention provides a granular compositions/formulations, which can be handled with ease, can flow easily, which are easy to measure out by volume, and leave no, or little residues in the emptied packaging after use.

The present invention provides for an agricultural pesticide formulation comprising:

an insecticidally effective amount of bifenthrin active;

2.4-52.8% by weight of carrier selected from the group consisting of precipitated silica, colloidal silica, attapulgite, china clay, talc, kaolin and combination thereof;

12.4 to 31.5% by weight of surfactant; and

a remaining amount of the formulation is a diluent selected from the group consisting of lactose, starch, urea, water soluble inorganic salts and a combination thereof.

The pesticide formulation may be in the form of granules.

In one embodiment of the present invention, the granular agricultural pesticide formulation comprises:

an insecticidally effective amount of bifenthrin active;

45.5-48.4% by weight of carrier selected from the group consisting of precipitated silica, colloidal silica, attapulgite, china clay, talc, kaolin and combination thereof;

12.4 to 28% by weight of surfactant; and 29 to 31% by weight of a diluent selected from the group consisting of lactose, starch, urea, water soluble inorganic salt and a combination thereof.

The bifenthrin active is preferably 9.5-10.5% by weight. The surfactant used in the granular agricultural pesticide formulation of the present invention is preferably selected from the group consisting of styrene acrylic dispersant polymers, acid resin copolymer based dispersing agents, potassium polycarboxylate, sodium alkyl naphthalene sulfonate blend, sodium diisopropylnaphthalenesulfonate, sodium salt of naphthalene sulfonate condensate, lignin sulfonate salts and combination thereof. More particularly, the surfactant is Atlox Metasperse 550 S, Borresperse NA, Tersperse 2700, Geropon SC-213, Morwet EFW, Supragil WP, Morwet D-425, lignin sulfonate salts or combination thereof. The pesticide formulation may also optionally contain a wetting and/or dispersing agent.

In an embodiment of the granular agricultural pesticide formulation of the present invention, at least one surfactant is 12.4-13.6% by weight.

In an embodiment of the granular agricultural pesticide formulation of the present invention, the diluent is lactose.

In an embodiment of the granular agricultural pesticide formulation of the present invention, the carrier is selected from the group consisting of precipitated silica, kaolin and combination thereof. In a preferable embodiment, the granular agricultural pesticide formulation has a carrier that is 2.4-2.6% by weight of precipitated silica; and 43.1-45.8% by weight of kaolin.

One preferable embodiment of the present invention is an agricultural pesticide formulation, commercially marketed as UPI Bifen 10 DF, comprising:

2.4-2.6% by weight of precipitated silica;

43.1-45.8% by weight of kaolin;

9.5-10.5% by weight of bifenthrin;

12.4-13.6% by weight of at least one surfactant; and

29-31% by weight of lactose.

In another preferable embodiment of the present invention, the granular agricultural pesticide formulation comprises:

9.5-10.5% of bifenthrin;

3.8-4.2% by weight of precipitated silica;

24.5-27.1% by weight of kaolin;

12.4-13.6% by weight of at least one surfactant;

44.2-48.8% by weight of lactose.

In another preferable embodiment of the present invention, the granular agricultural pesticide formulation comprising:

9.5-10.5% of bifenthrin;

2.4-2.6% by weight of precipitated silica;

26.6-29.4% by weight of at least one surfactant; and

a remaining amount of the formulation is ammonium sulphate as the soluble inorganic salt.

More preferably, the above granular agricultural pesticide formulation contains surfactants Supragil Wp and Borresperse Na, most preferably, the granular agricultural pesticide formulation comprises 2.9-3.2% of Supragil Wp and 23.8-26.3% of Borresperse Na.

The present invention also provides for a process of producing an agricultural pesticide formulation comprising the steps of:

mixing bifenthrin, in a desired amount; a carrier selected from the group consisting of precipitated silica, colloidal silica, attapulgite, china clay, talc, kaolin and combination thereof, and a surfactant, and a diluent selected from the group consisting of lactose, glucose, fructose, maltose, sucrose, in the anhydrous or hydrate forms, urea, water soluble or dispersible polymers, water soluble inorganic salts and a combination thereof; to form a mixture;

milling the mixture until the particles are 75 microns or less in size preferably D100'30 and ≦15 μm;

adding water to wet the milled mixture;

extruding the wet milled mixture to form granules; and drying the granules below the melting point of the pesticide to produce the agricultural pesticide formulation.

This process is especially useful in producing a formulation containing bifenthrin, chloropyrifos, lambda-cyhalothrin, gama-cyhalothrin trifluralin, pendimethalin, cypermethrin, alpha-cypermethrin, beta-cypermethrin and tefluthrin.

The process optimally uses the surfactant Atlox Metasperse 550 S, Tersperse 2700, Geropon SC-213, Morwet EFW, Supragil WP, Morwet D-425, lignin sulfonate salts or combination thereof, and diluents selected from the group consisting of lactose, glucose, fructose, maltose, sucrose in anhydrous or hydrate forms, urea, water soluble or dispersible polymers, water soluble inorganic salts and combination thereof, to form a mixture. The process optimally requires the wetting of the milled mixture with water, in the amount of 5 to 50% of the milled mixture, preferably 10 to 15%. Further, the process optionally adds a wetting agent or dispersing agent or both to produce the pesticide formulation.

In one preferred embodiment, the present process of producing an agricultural pesticide formulation comprises the steps of:

providing a crystalline powder of a pesticide with a melting point between about 30° C. to about 85° C.;

mixing the crystalline powder of a pesticide with a carrier selected from the group consisting of precipitated silica, colloidal silica, attapulgite china clay, talc, kaolin and combination thereof to form a first mixture;

mixing a solid surfactant Atlox Metasperse 550 S, Tersperse 2700, Geropon SC-213, Morwet EFW, Supragil WP, Morwet D-425, lignin sulfonate salts or combination thereof into the first mixture to form a second mixture;

mixing a diluent selected from the group consisting of lactose, glucose, fructose, maltose, sucrose, in the anhydrous or hydrate forms, urea, water soluble or dispersible polymers, water soluble inorganic salts and a combination thereof into the second mixture to form a third mixture;

milling the third mixture until the particles are 75 microns or less in size preferably D100≦30 and ≦15 μm;

adding water to wet the milled third mixture; extruding the wet milled third mixture to form granules; and drying the granules below the melting point of the pesticide to produce the agricultural pesticide formulation.

In one preferred embodiment, the present invention provides a formulation containing an insecticidally effective amount of bifenthrin active, a carrier such as precipitated silica, and kaolin, a surfactant component selected from Borresperse NA, Supragil WP, Atlox Metasperse 550S, Tersperse 2700, Geropon SC-213, Morwet EFW and combinations thereof, a diluent component selected from lactose, glucose, fructose, maltose, sucrose, wherein these sugars are in the anhydrous or hydrate forms, urea, water soluble or dispersible polymers, water soluble inorganic salts or a combination thereof.

The compositions of the present invention provide low toxicity, increased suspensibility and dispersion over compositions of the prior art. The lower toxicity of the compositions results in less skin irritation and sensitization to the user. Specifically, the compositions have lower dermal toxicity compared to available commercial powder formulation of bifenthrin products such as Bifenthrin 10 WSB (without Lactose). Further, the compositions have lower acute oral and acute inhalation toxicity. The compositions of the present invention further provide greater storage stability.

### DETAILED DESCRIPTION OF THE PRESENTLY PREFERRED EMBODIMENTS

An embodiment of the formulation of the present invention comprises bifenthrin active ingredient in a desired amount, a diluent, a surfactant and a carrier, optionally wetting agents and for dispersing agents. The optimal quality and the performance of the end product are greatly dependent upon the choice of the right ingredients used in the right proportion.

The present inventors have surprisingly found an unexpected reduction in the toxicity achieved by the use of a surfactants such as Borresperse NA, Supragil WP, Atlox Metasperse 550S, Morwet EFW, diluent such as water soluble inorganic salt such as ammonium sulphate or lactose-and carrier such as precipitated silica and kaolin in the formulations according to the present invention.

It was found by the inventors that the combination of bifenthrin with a surfactant, a diluent, and carrier greatly reduces the toxicity without compromising on its suspensibility and dispersibility and its desired insecticidal activity.

The general pesticide composition of the present invention comprises

(a) an insecticidally effective amount of a pesticide active component with a melting point of about 30° C. to about 85° C.;

(b) a surfactant;

(c) a diluent; and;

(d) a carrier.

The carrier may be precipitated silica, colloidal silica, attapulgite china clay, talc, kaolin or combination thereof, preferably precipitated silica and kaolin. The surfactants may be Atlox Metasperse 550 S, Tersperse 2700, Geropon SC-213, Morwet EFW, Supragil WP, Morwet D-425, lignin sulfonate salts as Borreperse NA or combination thereof. The diluents may be lactose, glucose, fructose, maltose, sucrose, in the anhydrous or hydrate forms, urea, water-soluble or dispersible polymers, water soluble inorganic salts or a combination thereof, preferably lactose and water soluble inorganic salt such as ammonium sulphate. Diluents may be lactose and water soluble inorganic salt such as ammonium sulphate. Without wishing to be bound by theory, it is believed that water soluble inorganic salt such as ammonium sulphate and the carbohydrate starch such as lactose, act-as an in situ film forming or surface coating agent in the pesticide composition, coating the active and carrier. When the pesticide composition is extruded and dried in the form of granules, it is believed that lactose and the water soluble inorganic salt such as ammonium sulphate—form a coating on the granules. It is believed that lactose and the water soluble inorganic salt such as ammonium sulphate coating contributes to the desired reduced toxicity of the pesticide composition, thus allowing the composition to be used without the need to be contained in water soluble bags or other packaging to avoid direct exposure to users.

Tests were conducted on granular formulations that contain 10% bifenthrin and various combinations of carrier (which appear to act as a solubility modulating agent), surfactants and diluents. Testing of the formulations showed that the low toxicity, superior suspensibility and dispersion, which were achieved by the granular formulations that contained specific combinations of surfactants, diluents and carriers.

TABLE 1
Toxicity Results:
Toxicity Results:

| | | Bifenthrin 10 WSB |
|---|---|---|
| | UPI Bifen 10 DF | (without Lactose) |
| Acute Oral Tox | LD₅₀ 550 mg/kg | LD₅₀ 335 mg/kg |
| Acute Inhalation | LC₅₀ 5.869 mg/kg | LC₅₀ 3.35 mg/kg |

Using the methods described herein, the following exemplary formulations were prepared and tested. It should be understood however that the exemplary formulations described herein describe the invention for purposes of illustration only and are not intended to limit the scope of the appended claims or the invention in any manner.

For all of the below described formulations, the United States Environmental Protection Agency has published its Product Properties Test Guidelines (EPA 712-96-012, August 1996) related to pesticides that allows for upper and lower certified limits for active and inert ingredients of 3, 5 or 10% of the nominal concentration for each ingredient in the pesticide formulation. This allows for slight variations in the amount of each ingredient in the testing of pesticides and potentially toxic substances, and the development of test data that must be submitted to the United States Environmental Protection Agency for review under Federal regulations. These test data includes toxicity and heat and storage stability results. These EPA Guidelines are hereby incorporated by reference into the present application.

Compositions

The below compositions may be prepared by the following process of producing an agricultural pesticide formulation comprises the steps of: Mixing the 10.50 g of Bifenthrin technical with 2.50 g of precipitated silica and grinding it and blending to form a first mixture; thereafter adding 10.00 g of Atlox Metasperse 550 S and 3.0 g of Morwet-EFW to the first mixture to form a second mixture; then 30.0 g of Lactose and 43.82 g of Kaolin were mixed with the second mixture to form a third mixture; milling the third mixture until the particles are 75 microns or less in size preferably D100≦≦30; and D90≦≦15 μm; adding 12.28 g water to wet the milled third mixture; extruding the wet milled third mixture to form granules; and drying the granules below the melting point of the pesticide to produce the agricultural pesticide formulation.

Airjet Milling Process

Another process for making the agricultural pesticide formulation of the present invention comprises the steps of:
1) Weighing all the raw material and blending in suitable blender to produce a premix
2) Grinding the premix through Air-jet mill to get the particle size D100≦30 micron
3) Preparing the dough using water needed to suit extrusion requirement for DF.
4) Extruding the material on suitable extrude where product temperature will not rise more 45-50° C.
5) Drying the extrudes using continuous or fluidized bed drier or static cum running bed drier, at a temperature not more than 45-50° C.; and optionally
6) Sizing the material to remove off spec material.

The Airjet milling process above was used to produce the below Composition 1.

TABLE 2
Composition 1 with nominal amounts of each ingredient

| Ingredients | % w/w | function |
|---|---|---|
| Bifenthrin | 10.00 | Active ingredient |
| Precipited silica | 02.50 | Inert |
| Supragil Wp | 03.00 | Wetting agent |
| Borresperse Na | 25.00 | dispersant |
| Ammonium sulphate | QS to 100 | Inert |

Below summarizes the heat and storage stability of Composition 1.

TABLE 3
Heat Stability data of composition 1

| Properties | 0 days | 14 days |
|---|---|---|
| Appearance | Brown color | Brown color |
| | free flowing | free flowing |
| | granules | granules |
| Bifenthrin content % w/w | 10.25 | 10.24 |
| Suspensibility | 98.32 | 99.76 |
| (gravimetric) % w/w | | |
| % Wet sieve retention | 0.05 | 0.06 |
| on 75μ test sieve | | |
| Persistent foam in ml | 3 | 3 |
| pH of 1% aq. suspension | 5.5 | 5.73 |
| No of inversion | 11 | 13 |

TABLE 4
Real time data storage Stability data of composition 1

| | 0 | 6 | 12 | 18 | 24 | 30 |
|---|---|---|---|---|---|---|
| Properties | days | month | month | month | month | month |
| Appearance | Brown | Brown | Brown | Brown | Brown | Brown |
| | color | color | color | color | color | color |
| | free | free | free | free | free | free |
| | flowing | flowing | flowing | flowing | flowing | flowing |
| | granules | granules | granules | granules | granules | granules |
| Bifenthrin | 10.25 | 10.26 | 10.24 | 10.21 | 10.20 | 10.19 |
| content % | | | | | | |
| w/w | | | | | | |
| Suspensibility | 98.32 | 99.21 | 98.77 | 97.52 | 98.30 | 97.88 |
| (gravimetric) | | | | | | |
| % w/w | | | | | | |
| % Wet sieve | 0.05 | 0.06 | 0.08 | 0.1 | 0.09 | 0.12 |
| retention on | | | | | | |
| 75μ test | | | | | | |
| sieve | | | | | | |
| Persistent | 3 | 3 | 4.5 | 4 | 6 | 5 |
| foam in ml | | | | | | |
| pH of 1% aq. | 5.5 | 5.75 | 5.86 | 5.90 | 6.01 | 5.90 |
| suspension | | | | | | |
| No of | 11 | 12 | 13 | 12 | 14 | 16 |
| inversion | | | | | | |

The following are a few more examples of agricultural pesticide formulations with nominal amounts of each ingredient.

TABLE 5

| | | | | | Gravimetric |
|---|---|---|---|---|---|
| | Active | | | | suspensibility |
| Sr. No. | ingredient (%) | Surfactants (%) | Diluent (%) | Carrier (%) | % by mass |
| 2 | Bifenthrin | Borresperse | Lactose (12) + | Kaolin (28.7) + | 81.6 |
| | (11.22) | NA (2.5) | Starch (20.08) | precipitated | |
| | | | | silica (3) | |
| 3 | Bifenthrin | Tersperse | Ammonium | Attapulgite | 85.66 |
| | (9.18) | 2700 (%) + | sulphate | clay (5) + | |
| | | Borresprse NA | (65.82) | precipitated | |
| | | (12) + Supragil | | silica (3) | |
| | | WP (3) | | | |
| 4 | Bifenthrin | Borresperse | Ammonium | Precipitated | 90.32 |
| | (10.2) | NA (25) + | sulphate | silica (2.55) | |
| | | Supragil WP (3) | (59.25) | | |
| 5 | Bifenthrin | Morwet D-425 | Urea (46.8) | China clay | 86.3 |
| | (9.7) | (10) + | | (15) + | |
| | | Borresperse | | Precipitated | |
| | | NA (15) | | silica (3.5) | |
| 6 | Bifenthrin | Atlox | Lactose (5) + | Talc (5) + | 82.07 |
| | (10.72) | Metasperse | Ammomium | precipitated | |
| | | 550s (10) + | sulphate ( | silica (5) | |
| | | Morwet EFW (4) | | | |
| 7 | Bifenthrin | Geropon SC | Sucrose (10) | Kaolin | 80.33 |
| | (10.2) | 213 (10) + | | ((64.8) | |
| | | Supragil WP (5) | | | |

TABLE 6

| | | | | | Gravimetric |
|---|---|---|---|---|---|
| | Active | | | | suspensibility |
| Sr. No. | ingredient (%) | Surfactants (%) | Diluent (%) | Carrier (%) | % by mass |
| 8 | Bifenthrin | Tersprse | Ammonium | Kaolin (10) + | 76.3 |
| | (9.21) | 2700/Metasprse | sulphate | Precipitated | |
| | | 550s (10) + | (61.8) | silica (4) | |
| | | Supragil WP (5) | | | |
| 9 | Bifenthrin | Atlox | Lactose | Kaolin | 92.43 |
| | (10.2) | Metasperse | (46.5) | (25.79) + | |
| | | 550s (10) + | | Precipitated | |
| | | Morwet EFW (3) | | silica (4) | |
| 10 | Bifenthrin | Geropon SC | Starch | Kaolin | 80.19 |
| | (10.72) | 213 (10) | (46.5) | (32.78) | |
| 11 | Bifenthrin | Morwet D-425 | Ammonium | Precipitated | 88.62 |
| | (11.23) | (5) + Atlox | sulphate | silica (3.77) | |
| | | Metasprse 550s (10) | (15) + | | |
| | | | Lactose (55) | | |
| 13 | Bifenthrin | Borresprse NA | Urea (10) | Precipitated | 83.54 |
| | (9.7) | (25) + Supragil | | silica (5) + | |
| | | WP (5) | | China Clay (45.3) | |
| 14 | Bifenthrin | Atlox | Lactose (30) + | Attapulgite | 90.07 |
| | (10.2) | Metasperse | Ammonium | (5) + | |
| | | (10) + Supragil | sulphate (36.8) | precipitated | |
| | | WP (3) | | silica (5) | |

The following summarizes the heat and storage stability of Composition 9, which composition is listed above. Composition 9 is a representative agricultural pesticide formulation of the present invention.

TABLE 7
Heat Stability data of composition 9

| Properties | 0 days | 14 days |
|---|---|---|
| Appearance | Brown color | Brown color |
| | free flowing | free flowing |
| | granules | granules |
| Bifenthrin content % w/w | 10.2 | 10.18 |
| Suspensibility | 98.32 | 99.76 |
| (gravimetric) % w/w | | |
| % Wet sieve retention | 0.05 | 0.06 |
| on 75μ test sieve | | |
| Persistent foam in ml | 3 | 3 |
| pH of 1% aq. suspension | 5.5 | 5.73 |
| No of inversion | 11 | 13 |

TABLE 8
Real time data storage Stability data of composition 9

| | 0 | 6 | 12 | 18 | 24 | 30 |
|---|---|---|---|---|---|---|
| Properties | days | month | month | month | month | month |
| Appearance | Brown | Brown | Brown | Brown | Brown | Brown |
| | color | color | color | color | color | color |
| | free | free | free | free | free | free |
| | flowing | flowing | flowing | flowing | flowing | flowing |
| | granules | granules | granules | granules | granules | granules |
| Bifenthrin | 10.2 | 10.19 | 10.18 | 10.18 | 10.17 | 10.15 |
| content % | | | | | | |
| w/w | | | | | | |
| Suspensibility | 92.43 | 92.40 | 92.30 | 92.15 | 92.09 | 91.98 |
| (gravimetric) | | | | | | |
| % w/w | | | | | | |
| % Wet sieve | 0.05 | 0.06 | 0.08 | 0.09 | 0.09 | 0.13 |
| retention on | | | | | | |
| 75μ test | | | | | | |
| sieve | | | | | | |
| Persistent | 15 | 15 | 17 | 18 | 20 | 20 |
| foam in ml | | | | | | |
| pH of 1% aq. | 5.7 | 5.9 | 5.9 | 6.0 | 6.01 | 6.05 |
| suspension | | | | | | |
| No of | 12 | 12 | 14 | 15 | 15 | 17 |
| inversion | | | | | | |

We claim:

1. A granular agricultural pesticide formulation comprising:
an insecticidally effective amount of bifenthrin active;
2.4-52.8% by weight of carrier selected from the group consisting of precipitated silica, colloidal silica, attapulgite, china clay, talc, kaolin and combination thereof;
12.4 to 31.5% by weight of surfactant; and
a remaining amount of the formulation is a diluent selected from the group consisting of lactose, starch, urea, water soluble inorganic salts and a combination thereof.

2. The granular agricultural pesticide formulation of claim 1 comprising:
an insecticidally effective amount of bifenthrin active;
45.5-48.4% by weight of carrier selected from the group consisting of precipitated silica, colloidal silica, attapulgite, china clay, talc, kaolin and combination thereof;
12.4 to 28% by weight of surfactant; and
29 to 31% by weight of a diluent selected from the group consisting of lactose, starch, urea, water soluble inorganic salt and a combination thereof.

3. The granular agricultural pesticide formulation of claim 1, wherein the bifenthrin active is 9.5-10.5% by weight.

4. The granular agricultural pesticide formulation of claim 1, wherein the surfactant is selected from the group consisting of styrene acrylic dispersant polymers, acid resin copolymer based dispersing agents, potassium polycarboxylate, sodium alkyl naphthalene sulfonate blend, sodium diisopropylnaphthalenesulfonate, sodium salt of naphthalene sulfonate condensate, lignin sulfonate salts and combination thereof.

5. The granular agricultural pesticide formulation of claim 1, wherein the surfactant is Atlox Metasperse 550 S, Borresperse NA, Tersperse 2700, Geropon SC-213, Morwet EFW, Supragil WP, Morwet D-425, lignin sulfonate salts or combination thereof.

6. The granular agricultural pesticide formulation of claim 2, wherein at least one surfactant is 12.4-13.6% by weight.

7. The granular agricultural pesticide formulation of claim 2, wherein the diluent is lactose.

8. The granular agricultural pesticide formulation of claim 2, wherein the carrier is selected from the group consisting of precipitated silica, kaolin and combination thereof.

9. The granular agricultural pesticide formulation of claim 2, wherein the carrier is
2.4-2.6% by weight of precipitated silica; and
43.1-45.8% by weight of kaolin.

10. An agricultural pesticide formulation of claim 2 comprising:
2.4-2.6% by weight of precipitated silica;
43.1-45.8% by weight of kaolin;
9.5-10.5% by weight of bifenthrin;
12.4-13.6% by weight of at least one surfactant; and
29-31% by weight of lactose.

11. The granular agricultural pesticide formulation of claim 1 comprising:
9.5-10.5% of bifenthrin active;
3.8-4.2% by weight of precipitated silica;
24.5-27.1% by weight of kaolin;
12.4-13.6% by weight of at least one surfactant;
44.2-48.8% by weight of lactose.

12. The granular agricultural pesticide formulation of claim 11 wherein the surfactant is Atlox Metasperse 550s and Morwet EFW.

13. The granular agricultural pesticide formulation of claim 1 comprising:
9.5-10.5% of bifenthrin active;
2.4-2.6% by weight of precipitated silica;
26.6-29.4% by weight of at least one surfactant; and
a remaining amount of the formulation is ammonium sulphate as the soluble inorganic salt.

14. The granular agricultural pesticide formulation of claim 13 wherein the surfactant is Supragil Wp and Borresperse Na.

15. The granular agricultural pesticide formulation of claim 14 comprising 2.9-3.2% of Supragil Wp and 23.8-26.3% of Borresperse Na.
